(19) United States
(12) Patent Application Publication
(10) Pub. No.: US 2015/0332589 A1
(43) Pub. Date: Nov. 19, 2015

(54) MANAGING TRANSIT SIGNAL PRIORITY (TSP) REQUESTS

(71) Applicant: Global Traffic Technologies, LLC, St. Paul, MN (US)

(72) Inventor: Kevin Clare Eichhorst, Owatonna, MN (US)

(73) Assignee: Global Traffic Technologies, LLC, St. Paul, MN (US)

(21) Appl. No.: 14/277,976

(22) Filed: May 15, 2014

(51) Int. Cl. G08G 1/087

(52) U.S. Cl. CPC G08G 1/087

(57) ABSTRACT

Approaches for managing transit signal priority (TSP) requests are disclosed. The arrival of a first transit vehicle at a transit stop is detected, and a first value indicative of an actual arrival time is stored in a memory in response to the arrival of the first transit vehicle at the transit stop. A processor determines from the first value whether or not the actual arrival time of the first transit vehicle satisfies a scheduling parameter. In response to the actual arrival time of the first transit vehicle not satisfying the scheduling parameter, a priority request device is enabled to make TSP requests. In response to the actual arrival time of the first transit vehicle satisfying the scheduling parameter, the priority request device is disabled from making TSP requests.

### FIELD OF THE INVENTION

The disclosure is generally directed to managing traffic signal priority requests from transit vehicles.

### BACKGROUND

Traffic signals have long been used to regulate the flow of traffic at intersections. Generally, traffic signals have relied on timers or vehicle sensors to determine when to change traffic signal lights, thereby signaling alternating directions of traffic to stop, and others to proceed.

Emergency vehicles, such as police cars, fire trucks and ambulances, generally have the right to cross an intersection against a traffic signal. Emergency vehicles have in the past typically depended on horns, sirens and flashing lights to alert other drivers approaching the intersection that an emergency vehicle intends to cross the intersection. However, due to hearing impairment, air conditioning, audio systems and other distractions, often the driver of a vehicle approaching an intersection will not be aware of a warning being emitted by an approaching emergency vehicle.

Traffic control preemption systems assist authorized vehicles (police, fire and other public safety or transit vehicles) through signalized intersections by making preemption requests to the intersection controllers that control the traffic lights at the intersections. The intersection controller may respond to the preemption request from the vehicle by changing the intersection lights to green in the direction of travel of the approaching vehicle. This system improves the response time of public safety personnel, while reducing dangerous situations at intersections when an emergency vehicle is trying to cross on a red light. In addition, speed and schedule efficiency can be improved for transit vehicles.

There are presently a number of known traffic control preemption systems that have equipment installed at certain traffic signals and on authorized vehicles. One such system in use today is the OPTICOM® system. This system utilizes a high power strobe tube (emitter), which is located in or on the vehicle, that generates light pulses at a predetermined rate, typically 10 Hz or 14 Hz. A receiver, which includes a photodetector and associated electronics, is typically mounted on the mast arm located at the intersection and produces a series of voltage pulses, the number of which are proportional to the intensity of light pulses received from the emitter. The emitter generates sufficient radiant power to be detected from over 2500 feet away. The conventional strobe tube emitter generates broad spectrum light. However, an optical filter is used on the detector to restrict its sensitivity to light only in the near infrared (IR) spectrum. This minimizes interference from other sources of light.

Intensity levels are associated with each intersection approach to determine when a detected vehicle is within range of the intersection. Vehicles with valid security codes and a sufficient intensity level are reviewed with other detected vehicles to determine the highest priority vehicle. Vehicles of equivalent priority are selected in a first come, first served manner. A preemption request is issued to the controller for the approach direction with the highest priority vehicle travelling on it.

Another common system in use today is the OPTICOM Global Positioning System (GPS) priority control system. This system utilizes a GPS receiver in the vehicle to determine location, speed and heading of the vehicle. The information is combined with security coding information that consists of an agency identifier, vehicle class, and vehicle ID, and is broadcast via a proprietary 2.4 GHz radio.

An equivalent 2.4 GHz radio located at the intersection along with associated electronics receives the broadcasted vehicle information. Approaches to the intersection are mapped using either collected GPS readings from a vehicle traversing the approaches or using location information taken from a map database. The vehicle location and direction are used to determine on which of the mapped approaches the vehicle is approaching toward the intersection and the relative proximity to it. The speed and location of the vehicle is used to determine the estimated time of arrival (ETA) at the intersection and the travel distance from the intersection. ETA and travel distances are associated with each intersection approach to determine when a detected vehicle is within range of the intersection and therefore a preemption candidate. Preemption candidates with valid security codes are reviewed with other detected vehicles to determine the highest priority vehicle. Vehicles of equivalent priority are selected in a first come, first served manner. A preemption request is issued to the controller for the approach direction with the highest priority vehicle travelling on it.

With metropolitan wide networks becoming more prevalent, additional means for detecting vehicles via wired networks, such as Ethernet or fiber optics, and wireless networks, such as cellular, Mesh or 802.11b/g, may be available. With network connectivity to the intersection, vehicle tracking information may be delivered over a network medium. In this instance, the vehicle location is either broadcast by the vehicle itself over the network or it may be broadcast by an intermediary gateway on the network that bridges between, for example, a wireless medium used by the vehicle and a wired network on which the intersection electronics resides. In this case, the vehicle or an intermediary reports, via the network, the vehicle's security information, location, speed and heading along with the current time on the vehicle, intersections on the network receive the vehicle information and evaluate the position using approach maps as described in the Opticom GPS system. The security coding could be identical to the Opticom GPS system or employ another coding scheme.

It is important that transit vehicles adhere to published schedules in order to satisfy riders' needs and ultimately to ensure the success of designated routes. If a transit vehicle arrives late to a scheduled stop or departs early, riders may be inconvenienced by having to wait for the next transit vehicle. If transit vehicles persistently fail to adhere to the published schedules, some riders may opt for alternative means of transportation. Declining ridership may affect the financial viability of certain routes.

### SUMMARY

According to one embodiment, a method is provided for managing transit signal priority (TSP) requests. The method includes detecting arrival of a first transit vehicle at a transit stop and storing a first value indicative of an actual arrival time in a memory in response to the arrival of the first transit vehicle at the transit stop. A processor determines from the first value whether or not the actual arrival time of the first transit vehicle satisfies a scheduling parameter. In response to the actual arrival time of the first transit vehicle not satisfying the scheduling parameter, a priority request device is enabled to make TSP requests. In response to the actual arrival time of the first transit vehicle satisfying the scheduling parameter, the priority request device is disabled from making TSP requests.

In another embodiment, a system for managing transit signal priority (TSP) requests of a transit vehicle includes a priority request device and a transit-stop module. The priority request device is configured to be mounted to the transit vehicle and to determine a current location of the transit vehicle. The priority request device transmits vehicle location information indicative of the current location. The transit-stop module is configured for placement at a transit stop and to store a scheduling parameter and transit-stop location information indicative of a geographical location of the transit stop. The transit-stop module receives the vehicle location information transmitted by the priority request device and determines whether or not the vehicle location information matches the transit-stop location information. An actual arrival time is determined in response to the vehicle location information matching the transit-stop location information. The transit-stop module determines whether or not the actual arrival time of the transit vehicle satisfies the scheduling parameter and transmits a signal indicative of an adherence status to the priority request device. The adherence status indicates whether or not the actual arrival time of the first transit vehicle satisfies the scheduling parameter. The priority request device is further configured to enable making TSP requests in response to the adherence status indicating the actual arrival time of the first transit vehicle does not satisfy the scheduling parameter, and to disable making TSP requests in response to the adherence status indicating the actual arrival time of the first transit vehicle satisfies the scheduling parameter.

In another system for managing transit signal priority (TSP) requests of a transit vehicle, a priority request device is configured to be mounted to the transit vehicle and configured to determine a current location of the transit vehicle and transmit vehicle location information indicative of the current location. A transit-stop module is configured to be placed at a transit stop and to store stop location information indicative of a geographical location of the transit stop. The transit-stop module receives the vehicle location information transmitted by the priority request device and determines whether or not the vehicle location information matches the stop location information. The transit-stop module determines an actual arrival time in response to the vehicle location information matching the stop location information and transmits a first value indicative of the actual arrival time. A server is coupled to the transit-stop module and is configured to store a schedule parameter and receive the first value from the transit-stop module. The server determines whether or not the first value satisfies the scheduling parameter; and transmits data that indicate whether or not the first value satisfies the scheduling parameter to the transit-stop module. The transit stop module is further configured to transmit a signal indicative of an adherence status to the priority request device. The adherence status indicates whether or not the first value satisfies the scheduling parameter. The priority request device is further configured to enable making TSP requests in response to the adherence status indicating the first value does not satisfy the scheduling parameter, and to disable making TSP requests in response to the adherence status indicating the first value satisfies the scheduling parameter.

Yet another system for managing transit signal priority (TSP) requests of a transit vehicle includes a priority request device configured to be mounted to the transit vehicle and to determine a current location of the transit vehicle. The priority request device transmits vehicle location information indicative of the current location. A server is coupled to the transit-stop module and is configured to store stop location information indicative of a geographical location of the transit stop and receive the vehicle location information transmitted by the priority request device. The server determines whether or not the vehicle location information matches the stop location information and determines an actual arrival time in response to the vehicle location information matching the stop location information. The server stores a schedule parameter and determines whether or not the actual arrival time satisfies the scheduling parameter. The server transmits a signal indicative of an adherence status to the priority request device. The adherence status indicates whether or not the first value satisfies the scheduling parameter. The priority request device is further configured to enable making TSP requests in response to the adherence status indicating the first value does not satisfy the scheduling parameter, and to disable making TSP requests in response to the adherence status indicating the first value satisfies the scheduling parameter.

Another method of managing transit signal priority (TSP) requests includes detecting departure of a first transit vehicle from a transit stop. The method stores a first value indicative of an actual departure time in a memory in response to the departure of the first transit vehicle at the transit stop. A processor determines whether or not the actual departure time of the first transit vehicle satisfies a scheduling parameter based on the first value. A priority request device is enabled to make TSP requests in response to the actual departure time of the first transit vehicle not satisfying the scheduling parameter. The priority request device is disabled from making TSP requests in response to the actual departure time of the first transit vehicle satisfying the scheduling parameter.

The above summary of the present invention is not intended to describe each disclosed embodiment of the present invention. The figures and detailed description that follow provide additional example embodiments and aspects of the present invention.

### BRIEF DESCRIPTION OF THE DRAWINGS

Other aspects and advantages of the invention will become apparent upon review of the Detailed Description and upon reference to the drawings in which:

FIG. 1 is a flowchart of a process for managing the generation of TSP requests by a transit vehicle;

FIG. 2 is a flowchart of a process for determining whether or not the actual arrival/departure time of a transit vehicle at a transit stop satisfies a scheduling parameter;

FIG. 3 pictorially illustrates an example transit stop with one transit vehicle departing and another transit vehicle moving toward the transit stop;

FIG. 4 shows a data flow between a priority request device and a transit-stop module for enabling and disabling the sending of TSP requests by the priority request device;

FIG. 5 shows a dataflow between a priority request device, a transit-stop module, and a server for enabling or disabling the making of TSP requests by the priority request device;

FIG. 6 shows a dataflow between a priority request device and a server for enabling or disabling the making of TSP requests by the priority request device;

FIG. 7 shows a dataflow between a priority request device and a server for enabling or disabling the making of TSP requests by the priority request device;

FIG. 8 shows a diagram of a system in which a server is coupled to intersection modules and to a transit-stop module; and

FIG. 9 shows an example of a processor-based computing arrangement that may be adapted for use in a priority request device, a transit-stop module or in a server.

### DETAILED DESCRIPTION

The disclosed methods and systems for managing transit signal priority (TSP) requests involve the detection of the arrival or departure (arrival/departure) of a transit vehicle at a transit stop and using the actual arrival/departure time in combination with the assigned schedule of the transit vehicle to control the issuing of TSP requests from the transit vehicle. Rather than the transmitting of a TSP request from a transit vehicle to an intersection being conditioned on the continual monitoring of the location and speed of the vehicle and estimating the time of arrival at a scheduled stop, the disclosed methods and systems use the actual time of arrival/departure at a scheduled stop to control whether or not sending of TSP requests will be enabled or disabled. This approach may avoid unnecessarily disrupting the normal cycling of traffic signals with TSP requests from a vehicle that may be experiencing transitory or intermittent traffic conditions that are unlikely to affect the ability of the vehicle to stay on-schedule. Only when a transit vehicle is actually behind schedule, as indicated by the actual arrival/departure time at a transit stop, are TSP requests from the vehicle enabled. Similarly, actual arrival/departure times may be used to prevent bunching of transit vehicles at scheduled stops.

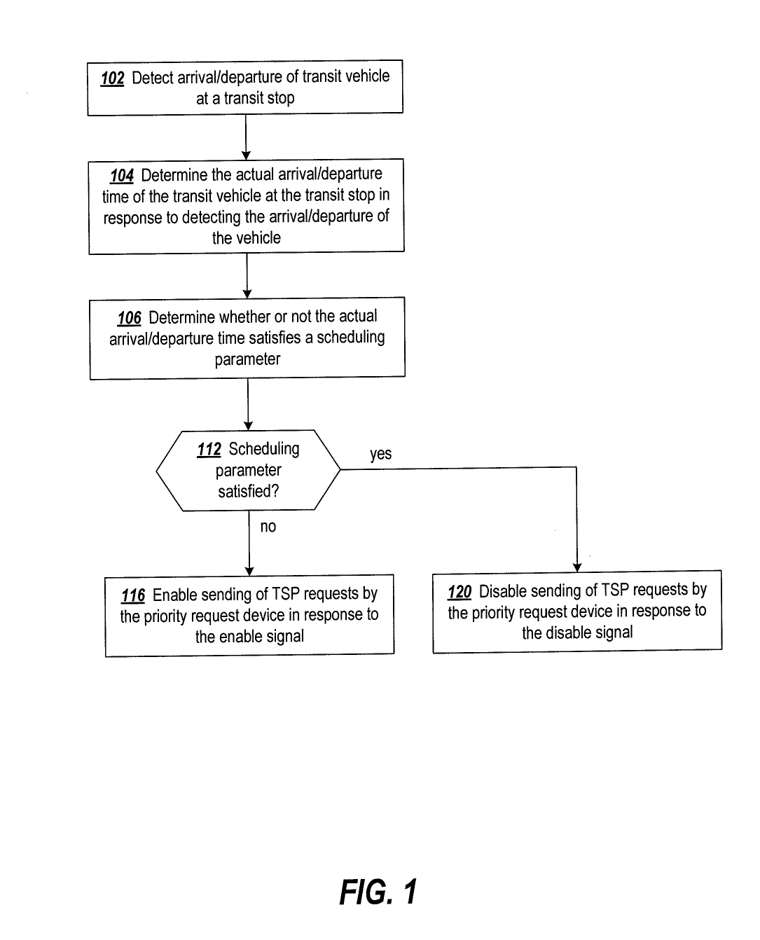

FIG. 1 is a flowchart of a process for managing the generation of TSP requests by a transit vehicle. The priority request device on a transit vehicle is automatically either enabled to make or disabled from making TSP requests based on whether or not the arrival/departure of a transit vehicle at a transit stop satisfies a scheduling parameter. The scheduling parameter may be either a scheduled time at which the transit vehicle is scheduled to arrive at or depart from the transit stop, or a scheduled headway between the transit vehicle and a previous transit vehicle on the same route.

At block 102, the arrival/departure of a transit vehicle at a transit stop is detected, and at block 104, the arrival/departure time of the transit vehicle at the transit stop is determined and a value indicative of the arrival/departure time may be stored in a memory of a processor-based system.

The arrival of the transit vehicle at a transit stop may be determined in various ways. In one approach, the current geographical location of the transit vehicle may be determined by a priority request device mounted in the vehicle. The priority request device may be a processor-based system that is connected to components that rely on satellite positioning systems, such as the GPS, to determine a vehicle's position. Each transit stop may have a transit-stop module that includes a processor and a memory and/or storage arrangement that is configured with geographical coordinates of the transit stop (or coordinates that define the boundaries of the transit stop) and schedule information for all transit vehicles on all routes that travel to the transit stop. The schedule information may include arrival and/or departure times for the transit vehicles on the different routes as well as a headway parameter for each route. The transit-stop module receives signals from the priority request device that indicate the current geographical location of the transit vehicle. In response to the current geographical location matching the geographical location of the transit stop, the transit-stop module obtains the current time from a time-of-day clock as may be maintained by the processor, and stores a value indicative of the current time in a memory as the actual arrival time.

In another approach, a central server may be used to determine whether or not transit vehicles are arriving and/or departing according to the desired schedule, and the priority request device in a transit vehicle may signal to the server that it has arrived at a transit stop. In this approach, the current speed of the vehicle and a door switch of the transit vehicle may be used to detect the arrival of the transit vehicle at a transit stop. The priority request device determines a current speed of the transit vehicle, for example, using changes in GPS location information over a period of time. The priority request device may also be connected to controls of the transit vehicle that open and close the vehicle's doors. In response to the current speed being 0 and a door of the transit vehicle being open, the priority request device transmits its location information and vehicle identifying information to the central server.

The departure of a transit vehicle may be similarly detected. That is, the priority request device on a vehicle may transmit its location to the transit-stop module, and the transit-stop module determines when the location indicates the transit vehicle has left the transit-stop. Alternatively, after the transit vehicle has stopped at the transit stop, the priority request device detects the departure based on the transit vehicle resuming movement and the closing of the door.

Block 106 determines whether or not the actual arrival/departure time satisfies a scheduling parameter. The scheduling parameter may reflect either the scheduled time at which the transit vehicle is scheduled to arrive at or depart from the transit stop (stop-time parameter) and/or a headway parameter that indicates the scheduled difference in arrival or departure times of consecutive transit vehicles on the same route. The headway parameter may be useful for multiple transit vehicles servicing the same route. In an example implementation, the scheduling parameter is selectable between the stop-time parameter and the headway parameter.

If the scheduling parameter is not satisfied, decision block 112 directs the process to block 116 where the priority request device enables the sending of TSP requests. If the scheduling parameter is the headway parameter, the vehicle for which the sending of TSP requests is enabled depends on whether the actual headway is greater than or less than desired between a leading vehicle and a trailing vehicle. If the actual headway is greater than desired, the sending of TSP requests may be enabled for the trailing vehicle in order to reduce the headway between vehicles. If the actual headway is less than desired, the sending of TSP requests may be enabled for the leading vehicle in order to increase the headway between vehicles. If the scheduling parameter is satisfied, decision block 112 directs the process to block 120 where the priority request device disables the sending of TSP requests.

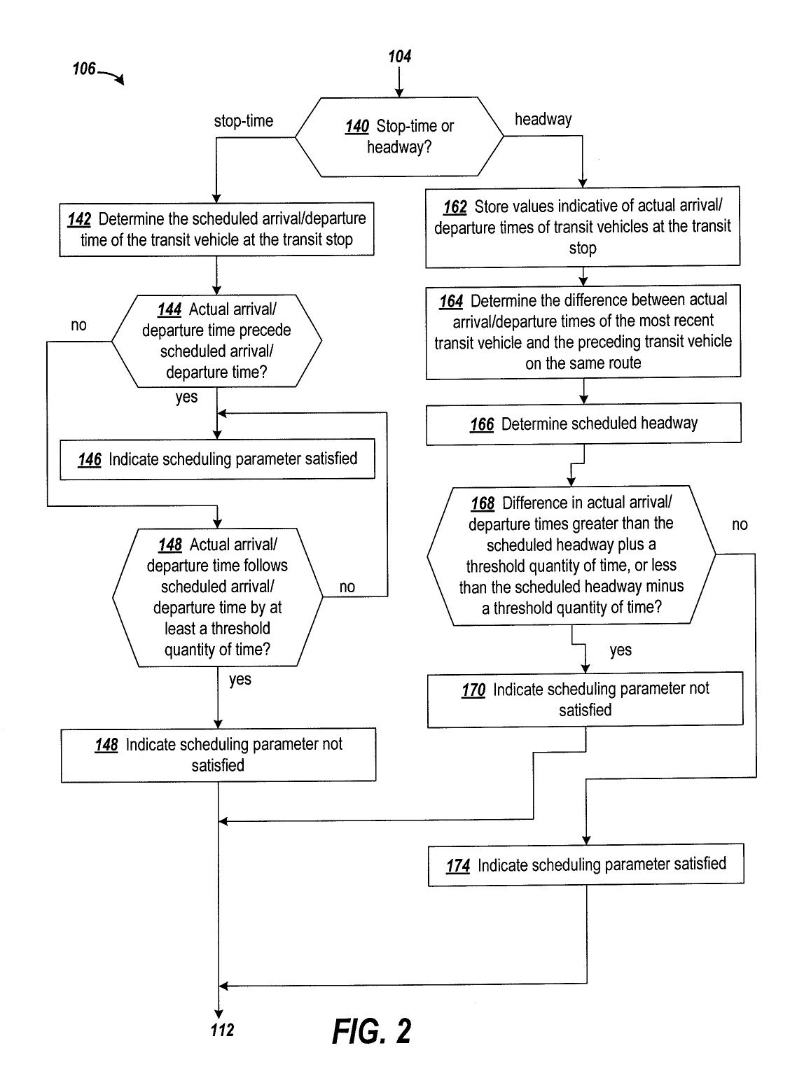

FIG. 2 is a flowchart of a process for determining whether or not the actual arrival/departure time of a transit vehicle at a transit stop satisfies a scheduling parameter. The process of FIG. 2 shows details of an example implementation of block 106 of FIG. 1. Decision block 140 tests whether the stop-time or headway parameter has been selected as the scheduling parameter. A system administrator may select the parameter by specifying the desired parameter as input to software components executing on a server or transit-stop module.

If the system is configured to use the stop-time parameter, at block 142 the process determines the scheduled arrival/departure time of the transit vehicle at the transit stop. The scheduled arrival/departure time may be read from a stored schedule of arrival/departure times that are associated with transit stops and the transit vehicles on routes that travel to the transit stops. In one implementation, the priority request device on a transit vehicle transmits information that indicates the vehicle's location, identity, and route information, which may be used to determine the relevant transit stop and the associated scheduled arrival/departure time.

Decision block 144 determines whether or not the actual arrival/departure time precedes the scheduled arrival/departure time. If so, the transit vehicle is determined to be on-time, and at block 146, a signal(s) may be output indicating that the scheduling parameter is satisfied. The indicating signal(s) may encode a data packet depending on the implementation.

If the actual arrival/departure time does not precede the scheduled arrival time, the process at decision block 148 determines whether or not the actual arrival/departure time follows the scheduled arrival/departure time by at least a threshold quantity of time. If the actual arrival/departure time follows the scheduled arrival/departure time by at least a threshold quantity of time, at block 150 a signal(s) may be output indicating that the scheduling parameter is not satisfied. The threshold quantity of time may be selected based on the particular scheduling needs of different routes. For example, one minute may be an acceptable threshold for some routes but unacceptable for other routes. Different routes and different transit stops may have different values for the threshold quantity. The threshold quantity may be a configurable parameter to allow a system administrator to adjust the value based on adherence of the transit vehicles to adhere to the desired schedules. If the actual arrival/departure time does not follow the scheduled arrival/departure time by at least the threshold quantity of time, the process is directed to block 146 to indicate that the scheduling parameter is satisfied as described above.

If the system is configured to use the headway parameter, at block 162 the system stores values that indicate the actual arrival/departure times of transit vehicles at the transit stop. The actual arrival/departure time of one transit vehicle is stored so that when the next transit vehicle arrives at or departs from the transit stop, the system can determine the time that separates the consecutive vehicles. At block 164, the difference between the arrival/departure times of the current transit vehicle and the previous transit vehicle is determined, and block 166 determines the scheduled headway for the route and transit stop. The scheduled headway may be read from a stored schedule of headway values that are associated with transit stops and the transit vehicles on routes that travel to the transit stops. Each headway value may be the difference between successive stop times of the schedule. The vehicle's location, identity, and route information as transmitted by the priority request device may be used to determine the relevant transit stop and the associated scheduled headway.

Decision block 168 determines whether or not the difference in actual arrival/departure times is greater than the scheduled headway plus a threshold quantity of time or the difference is less than the scheduled headway minus a threshold quantity of time. If so, the separation between the transit vehicle and the previous transit vehicle is determined to be greater than desired or less than desired, and at block 170, a signal(s) may be output indicating that the scheduling parameter is not satisfied. The indicating signal(s) may encode a data packet depending on the implementation.

If the difference in actual arrival/departure times is not greater than the scheduled headway plus the threshold quantity of time or not less than the scheduled headway minus the threshold quantity of time, at block 174 a signal(s) may be output indicating that the scheduling parameter is satisfied. The threshold quantity of time may be selected based on the particular scheduling needs of different routes. Different routes and different transit stops may have different values for the threshold quantity. The threshold quantity may be a configurable parameter to allow a system administrator to adjust the value based on how well transit vehicles are able to adhere to the desired schedules.

In one implementation, the scheduled headway may be varied by time-of-day or day-of-week. This may be useful for a route on which different numbers of transit vehicles service the route at different times and on different days. Scheduling information stored in a memory may include different values of the scheduled headway for each transit stop, with the different values associated with different ranges of times and/or days. The value of the scheduled headway may be selected based on the current day and time-of-day, and the days and times-of-day associated with the headway values. For example, the scheduling information for a transit stop on one route may specify a first value of the scheduled headway for weekday hours 7:00-9:00 a.m. and 3:00-6:00 p.m., a second value of the scheduled headway for weekday hours 9:00 a.m.-3:00 p.m., and a third value of the scheduled headway for weekends.

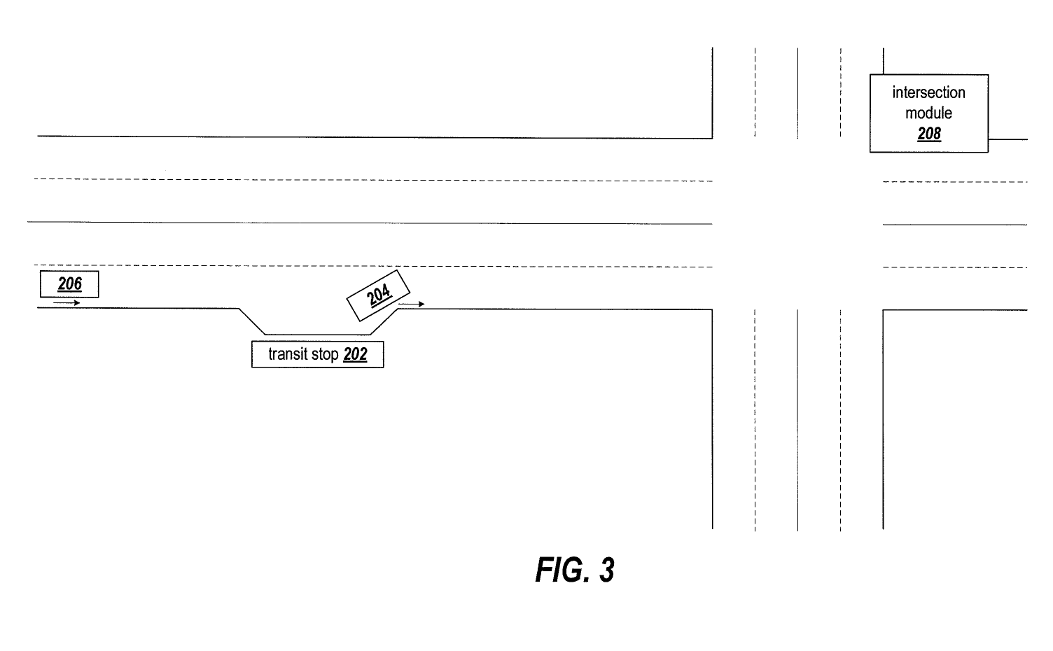

FIG. 3 pictorially illustrates an example transit stop 202 with one transit vehicle 204 departing and another transit vehicle 206 moving toward the transit stop. The transit vehicles may enable or disable the transmitting of TSPs to the intersection module 208 depending on whether or not the vehicles are adhering to the desired schedule. In one implementation, a transit-stop module (not shown) may be disposed at the transit stop 202, and each of the transit vehicles 204 and 206 may have a respective priority request device (not shown).

The arrival/departure of a transit vehicle is detected by either a priority request device, a transit-stop module, or a server, depending on the implementation. If the actual arrival/departure time of a transit vehicle as compared to the scheduled arrival/departure time for the vehicle indicates that the vehicle is behind schedule, the priority request device on that vehicle is enabled to make TSP requests. For example, if transit vehicle 204 is behind schedule, the priority request device on that vehicle is enabled to make TSP requests. After being enabled, the priority request device on the vehicle will transmit TSP requests when in range of intersection module 208.

The adherence of transit vehicles to a schedule may be alternatively based on the scheduled headway between vehicles. For example, transit vehicles 204 and 206 may be servicing the same route with scheduled arrival/departure times x minutes apart. If the arrival/departure time of transit vehicle 206 is more than x minutes plus a configured threshold quantity of time after the arrival/departure time of transit vehicle 204, the transit vehicle 206 is too far behind transit vehicle 204. In this scenario, the priority request device of transit vehicle 206 is enabled to make TSP requests. If the arrival/departure time of transit vehicle 206 is less than x minutes plus the threshold quantity of time after the arrival/departure time of transit vehicle 204, the transit vehicle 206 is within the desired headway behind transit vehicle 204, and the priority request device of transit vehicle 206 is disabled from making TSP requests in order to prevent bunching of the transit vehicles at other transit stops.

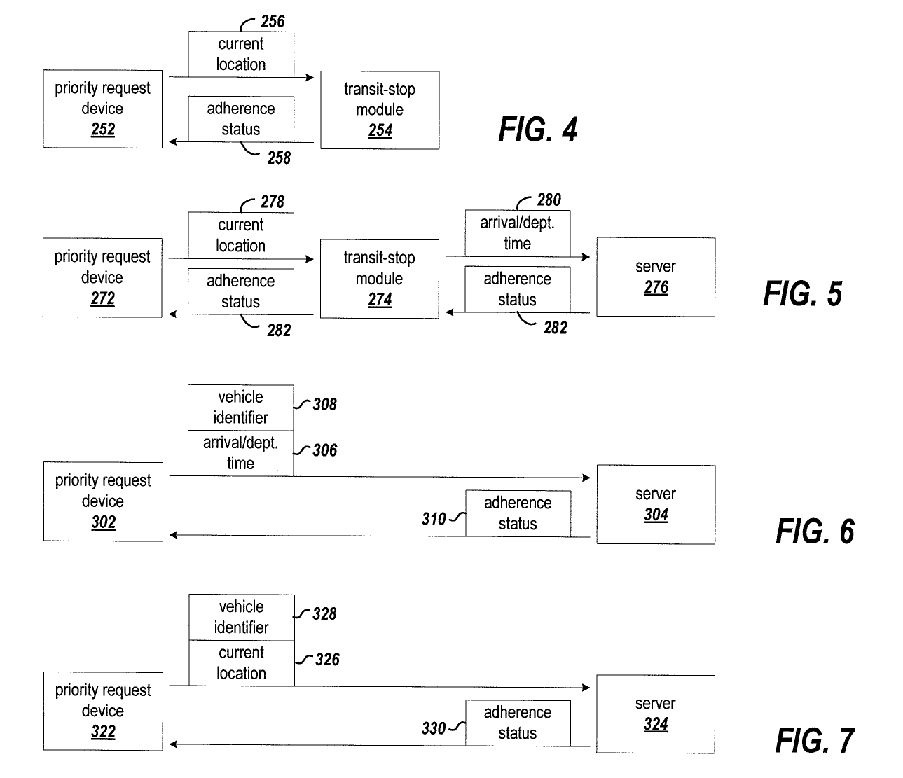

FIG. 4 shows a data flow between a priority request device 252 and a transit-stop module 254 for enabling and disabling the sending of TSP requests by the priority request device. Each transit vehicle is configured with a priority request device 252 having short-range wireless communications capabilities such as Bluetooth, ZigBee, WiFi, or a proprietary protocol such as the Opticom 2.4 GHz radio from Global Traffic Technologies, LLC. Each transit stop is equipped with a transit-stop module 254 having communications capabilities complementary to the priority request devices. The transit-stop module may be configured with schedule information for all routes on which transit vehicles stop at the transit stop. The schedule information may include stop times and headway for each route that uses the stop. The transit-stop module 254 may be further configured with location information that defines areas used to detect when a transit vehicle has arrived at and/or departed from the transit stop.

In an example implementation, the priority request device 252 listens on its wireless interface for communications from the transit-stop module 254. In response to receiving a broadcast from the transit-stop module, the priority request device transmits information including its current location 256, along with the vehicle's identity, heading, and speed. The transit-stop module uses the information from the priority request device to detect arrival at or departure from the transit stop.

Once an arrival or departure is detected, the transit-stop module determines the current time and compares the actual arrival/departure time to the scheduled stop time. The transit-stop module transmits signals to the priority request device to indicate the adherence status 258. If the arrival/departure time satisfies the schedule, the adherence status indicates the transit vehicle is on schedule, and the priority request device can disable making TSP requests. If the arrival/departure time does not satisfy the schedule, the adherence status indicates the transit vehicle is behind schedule, and the priority request device can enable making TSP requests.

FIG. 5 shows a dataflow between a priority request device 272, a transit-stop module 274, and a server 276 for enabling or disabling the making of TSP requests by the priority request device. The scheduling information is stored on the server, and the transit-stop device determines the arrival/departure time of the transit vehicle at the transit stop based on the current location information 278 transmitted by the priority request device. The transit stop module transmits data indicating the arrival/departure time 280 to the server. The server determines whether or not the transit vehicle is on-time and transmits the adherence status 282 to the transit-stop module. The transit-stop module in turn transmits the adherence status 284 to the priority request device, which enables or disables making TSP requests accordingly. The connection between the server and the transit-stop module may be a wired or wireless network.

FIG. 6 shows a dataflow between a priority request device 302 and a server 304 for enabling or disabling the making of TSP requests by the priority request device. The priority request device may communicate directly with the server over a cellular network. Alternatively, the communication may be by way of WiFi access points (not shown).

In this implementation, the priority request device 302 determines when it has arrived at or departed from a transit stop as previously described. The priority request device transmits the arrival/departure time 306 and its vehicle identifier 308 to the server 304. The server then determines whether or not the vehicle's arrival/departure time complies with the schedule stored at the server. The server then transmits the adherence status 310 to the priority request device, which enables or disables making TSP requests accordingly.

FIG. 7 shows a dataflow between a priority request device 322 and a server 324 for enabling or disabling the making of TSP requests by the priority request device. The priority request device may communicate directly with the server over a cellular network. Alternatively, the communication may be by way of WiFi access points (not shown).

In this implementation, the server determines when the transit vehicle has arrived at or departed from a transit stop based on information transmitted from the priority request device. The priority request device periodically transmits information including its current location 326, along with the vehicle's identity 328, heading, and speed.

The server uses the vehicles identifier and location to detect when the vehicle has arrived at or departed from a transit stop and then determines whether or not the vehicle's arrival/departure time complies with the schedule. The server transmits the adherence status 330 to the priority request device, which enables or disables making TSP requests accordingly.

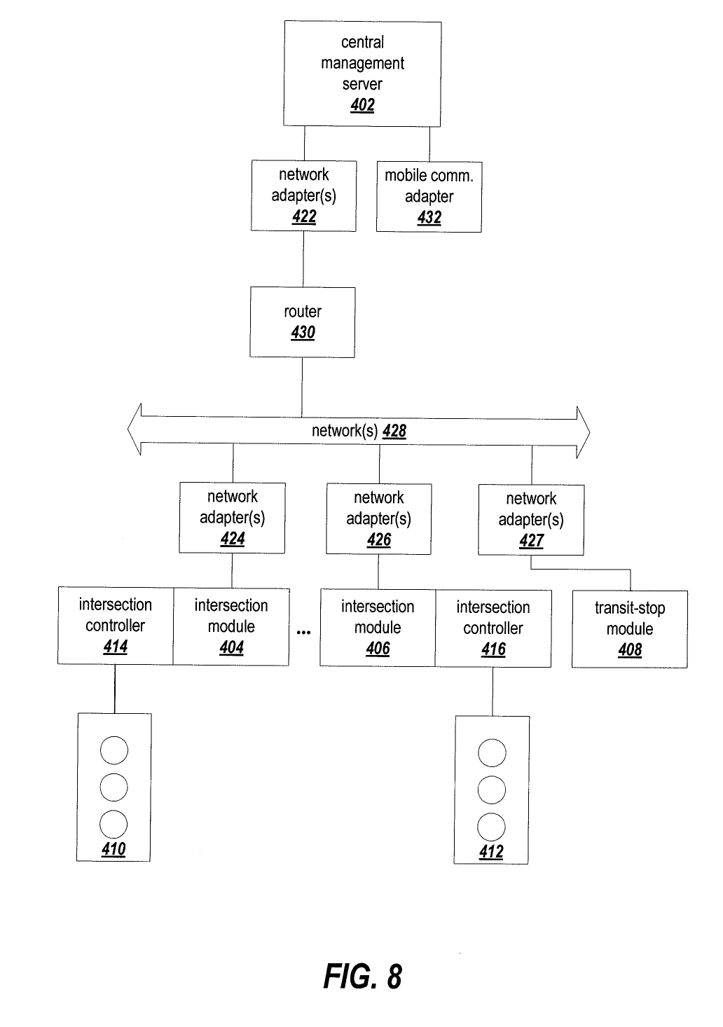

FIG. 8 shows a diagram of a system in which a server 402 is coupled to intersection modules 404 and 406 and to a transit-stop module 408. The server may be programmed to perform the processes previously described. Traffic lights 410 and 412, which may be disposed at separate intersections, are coupled to intersection controllers 414 and 416, respectively. Intersection controllers 414 and 416 are connected to respective intersection modules 404 and 406. The central management server, intersection modules, and transit-stop module 408 are respectively coupled to network adapters 422, 424, 426, and 427 for communication over a network 428. In various embodiments, a router or a network switch, as shown by router 430, may be coupled between the network adapter and the network. It is understood that the central management server and the intersection modules may be connected through more than one network, coupled by additional switches and routing resources, including a connection over the Internet. It is understood that numerous network transfer protocols may be used to establish, maintain, and route connections including: TCP/IP, UDP, NFS, ESP, SPX, etc. It is also understood that network transfer protocols may utilize one or more lower layers of protocol communication such as ATM, X.25, or MTP, and on various physical and wireless networks such as, Ethernet, ISDN, ADSL, SONET, IEEE 802.11, V.90/v92 analog transmission, etc.

The server 402 may further be coupled to a mobile communication adapter 432. The mobile communication adapter interfaces to a wireless communications network, such as a cellular network and provides communications between the server and the priority request devices in transit vehicles.

Further description of the intersection controllers and intersection modules, as well as the previously described priority request devices, may be found in U.S. Pat. No. 5,539,398, which is incorporated herein by reference in its entirety. U.S. patent application Ser. No. 13/034,211, entitled “Systems and Methods for Controlling Preemption of a Traffic Signal,” and filed on Feb. 24, 2011 by Roberts et al., is also incorporated herein by reference in its entirety.

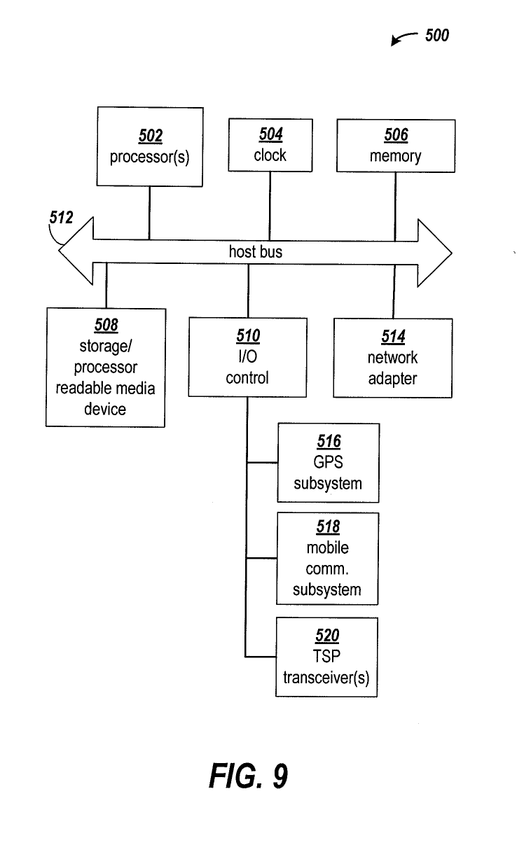

FIG. 9 shows an example of a processor-based computing arrangement 500 that may be adapted for use in a priority request device, a transit-stop module or in a server. It will be appreciated that various alternative computing arrangements, including one or more processors and a memory arrangement configured with program code, would be suitable for hosting the disclosed processes and data structures. The computer code, which implements the disclosed processes, is encoded in a processor executable format and may be stored and provided via a variety of computer-readable storage media or delivery channels such as magnetic or optical disks or tapes, electronic storage devices, or as application services over a network.

Computing arrangement 500 includes one or more processors 502, a clock signal generator 504, a memory arrangement 506, a storage arrangement 508, an input/output control unit 510, and a network adapter 514, all coupled to a host bus 512. The arrangement 500 may be implemented with separate components on a circuit board or may be implemented as a system on a chip.

The architecture of the computing arrangement depends on implementation requirements as would be recognized by those skilled in the art. The processor(s) 502 may be one or more general purpose processors, or a combination of one or more general purpose processors and suitable co-processors, one or more specialized processors (e.g., RISC, CISC, pipelined, etc.), or a multi-core processor, as specifically programmed to perform the algorithms described herein.

The memory arrangement 506 typically includes multiple levels of cache memory, and a main memory. The storage arrangement 508 may include local and/or remote persistent storage, such as provided by magnetic disks (not shown), flash, EPROM, or other non-volatile data storage. The storage device may be read or read/write capable. Further, the memory arrangement 506 and storage arrangement 508 may be combined in a single arrangement.

The processor(s) 502 executes the software from storage arrangement 508 and/or memory arrangement 506, reads data from and stores data to the storage arrangement 508 and/or memory arrangement 506, and communicates with external devices through the input/output control arrangement 510. These functions are synchronized by the clock signal generator 504. The resources of the computing arrangement may be managed by either an operating system (not shown), or a hardware control unit (not shown).

Different elements may be connected to the I/O control circuit 510 depending on whether the processing arrangement is used in a priority request device, a transit-stop module or in a server. The GPS subsystem 516 includes a receiver for receiving satellite positioning signals and providing real-time location information to the processor(s). The GPS subsystem may be integrated as part of the computing arrangement 500 or as a stand-alone module connected to the computing arrangement. The GPS subsystem may be unnecessary in the implementation of a server.

The mobile communications subsystem 518 provides mobile communication interfaces to the computing arrangement 500. The interfaces may be to cellular communications systems, for example. The mobile communications subsystem may be unnecessary depending on implementation requirements.

The TSP transceiver(s) 520 sends TSP requests to an intersection module in response to programmed control by the processor(s) 502 and may be configured to receive data from the intersection modules. The TSP transceiver(s) may be unnecessary in the implementation of a transit-stop module and in some implementations of a server.

Though aspects and features may in some cases be described in individual figures, it will be appreciated that features from one figure can be combined with features of another figure even though the combination is not explicitly shown or explicitly described as a combination.

The present invention is thought to be applicable to a variety of systems for controlling the flow of traffic. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A method of managing transit signal priority (TSP) requests, comprising:
detecting arrival of a first transit vehicle at a transit stop;
storing a first value indicative of an actual arrival time in a memory in response to the arrival of the first transit vehicle at the transit stop;
determining by a processor from the first value whether or not the actual arrival time of the first transit vehicle satisfies a scheduling parameter;
enabling a priority request device to make TSP requests in response to the actual arrival time of the first transit vehicle not satisfying the scheduling parameter; and
disabling the priority request device from making TSP requests in response to the actual arrival time of the first transit vehicle satisfying the scheduling parameter.

2. The method of claim 1, wherein the scheduling parameter indicates a scheduled arrival time of the first transit vehicle at the transit stop and the determining includes:
determining that the actual arrival time of the first transit vehicle satisfies the scheduling parameter in response to the first value indicating that the actual arrival time precedes the scheduled arrival time; and
determining that the actual arrival time of the first transit vehicle does not satisfy the scheduling parameter in response to the first value indicating that the actual arrival time is after the scheduled arrival time by a threshold quantity of time.

3. The method of claim 1, further comprising:
in response to a second transit vehicle arriving at the transit stop before the first transit vehicle, storing a second value indicative of an actual arrival time in association with an identifier of the second transit vehicle;
wherein the scheduling parameter indicates a scheduled headway separating the first transit vehicle from the second transit vehicle, and the determining includes:
determining that the actual arrival time of the first transit vehicle does not satisfy the scheduling parameter in response to the first and second values indicating that the actual arrival time of the first transit vehicle follows the actual arrival time of the second transit vehicle by more than the scheduled headway plus a threshold quantity of time, or indicating that the actual arrival time of the second transit vehicle precedes the actual arrival time of the first transit vehicle by less than the scheduled headway minus the threshold quantity of time; and
determining that the actual arrival time of the first transit vehicle satisfies the scheduling parameter in response to the first and second values indicating that the actual arrival time of the first transit vehicle follows the actual arrival time of the second transit vehicle by less than the scheduled headway plus the threshold quantity of time and indicating that the actual arrival time of the second transit vehicle precedes the actual arrival time of the first transit vehicle by more than the scheduled headway minus the threshold quantity of time.

4. The method of claim 3, wherein the scheduling parameter includes a plurality of headway values and associated times-of-day, and the method further comprising selecting one of the headway values as the scheduled headway based on current time-of-day and the times-of-day associated with the headway values.

5. The method of claim 4, wherein the plurality of headway values have associated days, and the method further comprising selecting one of the headway values as the scheduled headway based on a current day and the days associated with the headway values.

6. The method of claim 1, wherein the scheduling parameter is selectable between a stop-time parameter and a headway parameter, the stop-time parameter indicates a scheduled arrival time of the first transit vehicle at the transit stop, and the headway parameter indicates a scheduled headway separating two transit vehicles, the method further comprising:
in response to selection of the stop-time parameter, the determining includes:
determining that the actual arrival time of the first transit vehicle satisfies the scheduling parameter in response to the first value indicating that the actual arrival time precedes the scheduled arrival time; and
determining that the actual arrival time of the first transit vehicle does not satisfy the scheduling parameter in response to the first value indicating that the actual arrival time is after the scheduled arrival time by a threshold quantity of time;
in response to selection of the headway parameter:
in response to a second transit vehicle arriving at the transit stop before the first transit vehicle, storing a second value indicative of an actual arrival time in association with an identifier of the second transit vehicle; and
the determining includes:
determining that the actual arrival time of the first transit vehicle does not satisfy the scheduling parameter in response to the first and second values indicating that the actual arrival time of the first transit vehicle follows the actual arrival time of the second transit vehicle by more than the scheduled headway plus the threshold quantity of time, or indicating that the actual arrival time of the second transit vehicle precedes the actual arrival time of the first transit vehicle by less than the scheduled headway minus the threshold quantity of time; and
determining that the actual arrival time of the first transit vehicle satisfies the scheduling parameter in response to the first and second values indicating that the actual arrival time of the first transit vehicle follows the actual arrival time of the second transit vehicle by less than the scheduled headway plus the threshold quantity of time and indicating that the actual arrival time of the second transit vehicle precedes the actual arrival time of the first transit vehicle by more than the scheduled headway minus the threshold quantity of time.

7. The method of claim 1, further comprising:
storing the scheduling parameter on a transit-stop module;
wherein the determining includes the transit-stop module using the scheduling parameter and the first value to determine whether or not the arrival time of the first transit vehicle satisfies the scheduling parameter; and
transmitting a signal indicative of an adherence status from the transit-stop module to the priority request device, the adherence status indicating whether or not the actual arrival time of the first transit vehicle satisfies the scheduling parameter.

8. The method of claim 1, further comprising:
storing the scheduling parameter on a server that is coupled to a plurality of transit-stop modules at a plurality of transit stops;
transmitting the first value from one transit-stop module of the plurality of transit-stop modules to the server;
wherein the determining whether or not the arrival time of the first transit vehicle satisfies the scheduling parameter is performed by the server;
transmitting from the server to the one transit-stop module, data that indicate whether or not the arrival time of the first transit vehicle satisfies the scheduling parameter; and
transmitting a signal indicative of an adherence status from the one transit-stop module to the priority request device, the adherence status indicating whether or not the actual arrival time of the first transit vehicle satisfies the scheduling parameter.

9. The method of claim 1, further comprising:
determining a current geographical location of the first transit vehicle by the priority request device; and
in response to the current geographical location matching a geographical location of the transit stop, determining a current time, and setting the first value to a value indicative of the current time.

10. The method of claim 1, wherein the detecting arrival includes:
determining a current speed of the first transit vehicle; and
in response to the current speed being 0 and a door of the first transit vehicle being open, determining a current time, and setting the first value to a value indicative of the current time.

11. The method of claim 1, further comprising:
wherein the detecting arrival includes:
determining a current geographical location of the first transit vehicle by the priority request device;
transmitting information indicative of the current geographical location and identity of the first transit vehicle from the priority request device to a server that is coupled to a plurality of transit-stop modules at a plurality of transit stops; and
determining by the server whether or not the current geographical location matches a geographical location of the transit stop, wherein one transit-stop module of the plurality of transit-stop modules is located at the transit stop;
in response to the current geographical location matching the geographical location of the transit stop, determining a current time by the server, and setting the first value to a value indicative of the current time;
wherein the determining whether or not the arrival time of the first transit vehicle satisfies the scheduling parameter is performed by the server;
transmitting from the server to the one transit-stop module, data that indicate whether or not the arrival time of the first transit vehicle satisfies the scheduling parameter; and
transmitting a signal indicative of an adherence status from the one transit-stop module to the priority request device, the adherence status indicating whether or not the actual arrival time of the first transit vehicle satisfies the scheduling parameter.

12. The method of claim 1, further comprising:
detecting departure of the first transit vehicle from the transit stop;
storing a second value indicative of an actual departure time in association with an identifier of the first transit vehicle on a transit-stop module at the transit stop in response to the first transit vehicle departing from the transit stop;
determining from the second value whether or not the actual departure time of the first transit vehicle satisfies a departure parameter; and
transmitting a signal indicative of an adherence status from the transit-stop module to the priority request device, the adherence status indicating whether or not the actual departure time of the first transit vehicle satisfies the scheduling parameter;
wherein the enabling includes enabling the priority request device to make TSP requests in response to the adherence status indicating the actual departure time of the first transit vehicle does not satisfy the scheduling parameter;
wherein the disabling includes disabling the priority request device from making TSP requests in response to the adherence status indicating the actual departure time of the first transit vehicle satisfies the scheduling parameter.

13. A system for managing transit signal priority (TSP) requests, comprising:
a priority request device configured to be mounted to a first transit vehicle and configured to:
determine a current location of the first transit vehicle; and
transmit vehicle location information indicative of the current location;
a transit-stop module configured for placement at a transit stop and configured to:
store a scheduling parameter and transit-stop location information indicative of a geographical location of the transit stop;
receive the vehicle location information transmitted by the priority request device;
determine whether or not the vehicle location information matches the transit-stop location information;
determine an actual arrival time in response to the vehicle location information matching the transit-stop location information;
store a first value indicative of the actual arrival time in a memory;
determine whether or not the actual arrival time of the first transit vehicle satisfies the scheduling parameter; and
transmit a signal indicative of an adherence status to the priority request device, the adherence status indicating whether or not the actual arrival time of the first transit vehicle satisfies the scheduling parameter;
wherein the priority request device is further configured to:
enable making TSP requests in response to the adherence status indicating the actual arrival time of the first transit vehicle does not satisfy the scheduling parameter; and
disable making TSP requests in response to the adherence status indicating the actual arrival time of the first transit vehicle satisfies the scheduling parameter.

14. The system of claim 13, wherein the scheduling parameter indicates a scheduled arrival time of the first transit vehicle at the transit stop and the transit-stop module is further configured to:
determine that the actual arrival time of the first transit vehicle satisfies the scheduling parameter in response to the first value indicating that the actual arrival time precedes the scheduled arrival time; and
determine that the actual arrival time of the first transit vehicle does not satisfy the scheduling parameter in response to the first value indicating that the actual arrival time is after the scheduled arrival time by a threshold quantity of time.

15. The system of claim 13, wherein the transit-stop module is further configured to:
store, in response to a second transit vehicle arriving at the transit stop before the first transit vehicle, a second value indicative of an actual arrival time in association with an identifier of the second transit vehicle;
wherein the scheduling parameter indicates a scheduled headway separating the first transit vehicle from the second transit vehicle;
determine that the actual arrival time of the first transit vehicle does not satisfy the scheduling parameter in response to the first and second values indicating that the actual arrival time of the first transit vehicle follows the actual arrival time of the second transit vehicle by more than the scheduled headway plus a threshold quantity of time, or indicating that the actual arrival time of the second transit vehicle precedes the actual arrival time of the first transit vehicle by less than the scheduled headway minus the threshold quantity of time; and
determine that the actual arrival time of the first transit vehicle satisfies the scheduling parameter in response to the first and second values indicating that the actual arrival time of the first transit vehicle follows the actual arrival time of the second transit vehicle by less than the scheduled headway plus the threshold quantity of time and indicating that the actual arrival time of the second transit vehicle precedes the actual arrival time of the first transit vehicle by more than the scheduled headway minus the threshold quantity of time.

16. A system for managing transit signal priority (TSP) requests of, comprising:
a priority request device configured to be mounted to a first transit vehicle and configured to:
determine a current location of the first transit vehicle; and
transmit vehicle location information indicative of the current location;
a transit-stop module configured to be placed at a transit stop and configured to:
store stop location information indicative of a geographical location of the transit stop;
receive the vehicle location information transmitted by the priority request device;
determine whether or not the vehicle location information matches the stop location information;
determine an actual arrival time in response to the vehicle location information matching the stop location information; and
transmit a first value indicative of the actual arrival time; and
a server coupled to the transit-stop module and configured to:
store a scheduling parameter;
receive the first value from the transit-stop module;
determine whether or not the first value satisfies the scheduling parameter; and
transmit to the transit-stop module data that indicate whether or not the first value satisfies the scheduling parameter;
wherein the transit-stop module is further configured to:
transmit a signal indicative of an adherence status to the priority request device, the adherence status indicating whether or not the first value satisfies the scheduling parameter;
wherein the priority request device is further configured to:
enable making TSP requests in response to the adherence status indicating the first value does not satisfy the scheduling parameter; and
disable making TSP requests in response to the adherence status indicating the first value satisfies the scheduling parameter.

17. The system of claim 16, wherein the scheduling parameter indicates a scheduled arrival time of the first transit vehicle at the transit stop and the server is further configured to:
determine that the actual arrival time of the first transit vehicle satisfies the scheduling parameter in response to the first value indicating that the actual arrival time precedes the scheduled arrival time; and
determine that the actual arrival time of the first transit vehicle does not satisfy the scheduling parameter in response to the first value indicating that the actual arrival time is after the scheduled arrival time by a threshold quantity of time.

18. The system of claim 16, wherein the server is further configured to:
store, in response to a second transit vehicle arriving at the transit stop before the first transit vehicle, a second value indicative of an actual arrival time in association with an identifier of the second transit vehicle;
wherein the scheduling parameter indicates a scheduled headway separating the first transit vehicle from the second transit vehicle;
determine that the actual arrival time of the first transit vehicle does not satisfy the scheduling parameter in response to the first and second values indicating that the actual arrival time of the first transit vehicle follows the actual arrival time of the second transit vehicle by more than the scheduled headway plus a threshold quantity of time, or indicating that the actual arrival time of the second transit vehicle precedes the actual arrival time of the first transit vehicle by less than the scheduled headway minus the threshold quantity of time; and
determine that the actual arrival time of the first transit vehicle satisfies the scheduling parameter in response to the first and second values indicating that the actual arrival time of the first transit vehicle follows the actual arrival time of the second transit vehicle by less than the scheduled headway plus the threshold quantity of time and indicating that the actual arrival time of the second transit vehicle precedes the actual arrival time of the first transit vehicle by more than the scheduled headway minus the threshold quantity of time.

19. A system for managing transit signal priority (TSP) requests, comprising:
a priority request device configured to be mounted to a first transit vehicle and configured to:
determine a current location of the first transit vehicle; and
transmit vehicle location information indicative of the current location; and
a server coupled to the priority request device and configured to:
store stop location information indicative of a geographical location of a transit stop;
receive the vehicle location information transmitted by the priority request device;
determine whether or not the vehicle location information matches the stop location information;
determine an actual arrival time in response to the vehicle location information matching the stop location information;
store a first value indicative of the actual arrival time in a memory;
store a scheduling parameter;
determine whether or not the actual arrival time satisfies the scheduling parameter; and
transmit a signal indicative of an adherence status to the priority request device, the adherence status indicating whether or not the first value satisfies the scheduling parameter;
wherein the priority request device is further configured to:
enable making TSP requests in response to the adherence status indicating the first value does not satisfy the scheduling parameter; and
disable making TSP requests in response to the adherence status indicating the first value satisfies the scheduling parameter.

20. The system of claim 19, wherein the scheduling parameter indicates a scheduled arrival time of the first transit vehicle at the transit stop and the server is further configured to:
determine that the actual arrival time of the first transit vehicle satisfies the scheduling parameter in response to the first value indicating that the actual arrival time precedes the scheduled arrival time; and
determine that the actual arrival time of the first transit vehicle does not satisfy the scheduling parameter in response to the first value indicating that the actual arrival time is after the scheduled arrival time by a threshold quantity of time.

21. The system of claim 19, wherein the server is further configured to:
store, in response to a second transit vehicle arriving at the transit stop before the first transit vehicle, a second value indicative of an actual arrival time in association with an identifier of the second transit vehicle;
wherein the scheduling parameter indicates a scheduled headway separating the first transit vehicle from the second transit vehicle;
determine that the actual arrival time of the first transit vehicle does not satisfy the scheduling parameter in response to the first and second values indicating that the actual arrival time of the first transit vehicle follows the actual arrival time of the second transit vehicle by more than the scheduled headway plus a threshold quantity of time, or indicating that the actual arrival time of the second transit vehicle precedes the actual arrival time of the first transit vehicle by less than the scheduled headway minus the threshold quantity of time; and
determine that the actual arrival time of the first transit vehicle satisfies the scheduling parameter in response to the first and second values indicating that the actual arrival time of the first transit vehicle follows the actual arrival time of the second transit vehicle by less than the scheduled headway plus the threshold quantity of time and indicating that the actual arrival time of the second transit vehicle precedes the actual arrival time of the first transit vehicle by more than the scheduled headway minus the threshold quantity of time.

22. A method of managing transit signal priority (TSP) requests, comprising:
detecting departure of a first transit vehicle from a transit stop;
storing a first value indicative of an actual departure time in a memory in response to the departure of the first transit vehicle at the transit stop;
determining by a processor from the first value whether or not the actual departure time of the first transit vehicle satisfies a scheduling parameter;
enabling a priority request device to make TSP requests in response to the actual departure time of the first transit vehicle not satisfying the scheduling parameter; and
disabling the priority request device from making TSP requests in response to the actual departure time of the first transit vehicle satisfying the scheduling parameter.
